(19) United States
(12) Patent Application Publication
(10) Pub. No.: US 2026/0060168 A1
(43) Pub. Date: Mar. 5, 2026

(54) SYSTEMS AND METHODS FOR REAL-TIME MEASUREMENT AND CONTROL OF SOLID FERTILIZER COVERAGE ON AGRICULTURAL TARGETS

(71) Applicant: AgZen Inc., Somerville, MA (US)

(72) Inventor: Vishnu Jayaprakash, Somerville, MA (US)

(21) Appl. No.: 19/312,863

(22) Filed: Aug. 28, 2025

Related U.S. Application Data
(60) Provisional application No. 63/688,477, filed on Aug. 29, 2024.

(51) Int. Cl. A01C 21/00; G06V 20/10; G06V 20/17

(52) U.S. Cl. CPC A01C 21/005; A01C 21/007; G06V 20/17; G06V 20/188

(57) ABSTRACT

Presented herein are systems, methods, and devices for measurement and control of the coverage and/or spatial uniformity of dry (solid) fertilizer (e.g., powder, granules, and/or other particulate) that is automatically, mechanically distributed (e.g., via a spinner spreader) onto soil or another agricultural target.

### CROSS-REFERENCE TO RELATED APPLICATIONS

This application claims priority to and the benefit of U.S. Provisional Application No. 63/688,477 filed Aug. 29, 2024, the disclosure of which is incorporated herein by reference in its entirety.

### FIELD

This invention relates generally to agricultural systems and methods. More particularly, in certain embodiments, the invention relates to systems and methods for quantifying and/or enhancing the coverage and/or spatial uniformity of dry (solid) fertilizer that is automatically, mechanically distributed (e.g., via a spinner spreader) onto soil or other agricultural target.

### BACKGROUND

Fertilizer usage is ubiquitous within agriculture as it plays a vital role in ensuring optimal yields for crops. Farmers use large quantities of fertilizers to grow their plants and increase crop yield. Essential plant nutrients such as nitrogen, phosphorous, and potassium are applied to soils at different stages of the growing season to ensure that crops have the nutrition necessary to grow. The most common method to apply plant nutrition is to spread powdered or granular mixtures of the required nutrients using fertilizer spreaders or spinner spreaders. Dry fertilizers (powdered and granular) account for up to 80% of the fertilizer usage within the United States.

Fertilizer spreaders use a hopper and a combination of one or more spinning discs or impellers to fling solid fertilizer particles (e.g., powder and/or granules) outward in a broad pattern, as shown in FIG. 1.

Achieving a uniform spatial distribution of the fertilizer particles on the field is vital to ensure that crops are receiving optimal nutrition. FIG. 2 highlights the effect of improper calibration of the spinner spreader which can lead to several types of non-uniform distribution of fertilizer particles in the field. The graphs of FIG. 2 show different rates of fertilizer particles being applied with respect to the distance from a center mark. The center mark is shown by a “.” symbol on the x-axis of each of the graphs. The graphs of FIG. 2 (top 3 panels) show unsatisfactory application patterns of fertilizer, resulting in a “M”, “W”, or “Offside” application patterns. In the top panel, an unsatisfactory application pattern plus being too light behind the applicator yields an “M” shaped pattern of fertilizer distribution. In the second from the top panel, an unsatisfactory application pattern plus being too heavy behind the applicator yields a “W” shaped pattern of fertilizer distribution. In the third from the top panel, an unsatisfactory application pattern plus being too heavy on one side of the applicator yields an “Offside” pattern of fertilizer distribution. Such non-uniform distributions of crop nutrition can lead to areas of poor yield and are often characterized by striping in the crop, as shown in FIG. 2 (bottom panel). Crop striping can result from non-uniform nutrient delivery caused by poor calibration and use of a spinner spreader.

Fertilizer spreaders have several control levers to ensure that such non-uniform patterns can be corrected. FIG. 3 shows an exemplary standard dry (solid) fertilizer spinner spreader and various components of the spinner spreader. Several of these components can be adjusted to change the deposition/coverage pattern of solid material. From adjusting the revolutions per minute (RPM) of the spinner to optimizing the positioning of the flow divider and vanes, pattern corrections can be made by operators to correct non-uniform applications and achieve a more uniform deposition in the field. These adjustments are influenced by various factors including environmental conditions, the size and density of the solid materials, and the travel speed of the spreader.

Currently, farmers may conduct pan tests to estimate fertilizer coverage, but there are disadvantages of this technique. Pan testing is the current standard method of measuring dry fertilizer coverage and degree of uniformity of dry fertilizer that is deposited/spread onto soil. The method evaluates degree of uniformity across the swath and determines the type of spread pattern, the effective swath width, and the rate of application.

Pan tests may be conducted according to International Organization for Standardization (ISO) Standard 5690 (1984), and American Society of Agricultural and Biological Engineers (ASABE) Standard 341.4 (2015). Pan testing involves placing corrugated pans on the ground and measuring how many fertilizer pellets made it into each pan upon mechanical spreading. FIG. 4 shows an example of pan testing performed to quantify dry fertilizer spread pattern and uniformity.

While pan testing can provide an accurate representation of ground coverage, the test needs to be redone for every setting change implemented on the spreader. This can be incredibly tedious as each test can take upwards of an hour to complete. As a result, pan testing is done very rarely in the field, and this subsequently leads to poor calibrations and settings used in practice.

There is a need for reliable, practical, and easy-to-use tools to accurately measure and control solid fertilizer coverage on soils and other agricultural targets.

### SUMMARY

Presented herein are systems, methods, and devices for measurement and control of the coverage and/or spatial uniformity of dry (solid) fertilizer (e.g., powder, granules, and/or other particulate) that is automatically, mechanically distributed (e.g., via a spinner spreader) onto soil or another agricultural target. In certain embodiments, the systems, methods, and devices described herein provide for accurate, easy-to-implement, real-time estimation of dry (solid) fertilizer coverage and deposition distribution (e.g., spatial uniformity of fertilizer deposition) on soil.

In one aspect, the invention is directed to a system for automatically measuring solid fertilizer coverage (e.g., granules, powder, and/or other particulate) on a target agricultural surface (e.g., soil), the system comprising: one or more sensors [(e.g., optical or non-optical) (e.g., of a type such as a visible wavelength imaging sensor such as a camera, an infrared wavelength imaging sensor such as a Light Detection and Ranging (LiDAR) sensor, and/or a radio detection and ranging (radar) sensor)], wherein the one or more sensors capture (e.g., in real time) data (e.g., image data) reflecting the state of the target agricultural surface after and/or before distribution of the solid (e.g., dry) fertilizer (e.g., a mechanical spreader) by a spreader onto said target agricultural surface; a processor of a computing device; and a memory having instructions stored thereon, wherein the instructions, when executed by the processor, cause the processor to: receive the data (e.g., image data) captured by the one or more sensors reflecting the state of the target agricultural surface after and/or before distribution of the solid fertilizer; and either or both of (I) and (II) as follows: (I) use the data captured by the one or more sensors to automatically determine a fertilizer coverage value on the target agricultural surface; and (II) use the data captured by the one or more sensors (and/or the fertilizer coverage value determined in (I)) to automatically determine a value and/or adjustment of one or more fertilizer spreader parameters to achieve a desired level and/or uniformity of solid fertilizer coverage on the target agricultural surface.

In certain embodiments, the one or more sensors comprise at least one sensor positioned on or in one or more drones (e.g., unmanned aerial vehicle(s)) that capture overhead images (e.g., visible spectrum, infrared, radio waves, or otherwise) of the target agricultural surface.

In certain embodiments, the at least one sensor positioned on or in the one or more drones capture one or more images of a region of interest of the target surface before (in time) and/or after distribution of the solid fertilizer on the region of interest.

In certain embodiments, the one or more drones capture the one or more images before and/or after a fertilizer (e.g., an automatic, mechanical spreader with one or more adjustable parameters, e.g., a spreader that is a vehicle or is mounted on a vehicle) spreader moves through the region of interest of the target agricultural surface.

In certain embodiments, the fertilizer coverage value and/or the value and/or adjustment of the one or more fertilizer spreader parameters are determined using the one or more images captured by the one or more drones.

In certain embodiments, the one or more drones are flying drones [e.g., remote controlled drones, global positioning system (GPS) drones, fixed wind drones, multi-rotor drones, single-rotor helicopter drones, and/or fixed-wing hybrid VTOL (vertical take-off and landing) drones].

In certain embodiments, the overhead images of the target agricultural surface depict a region of interest that spans at least 1 m², at least 10 m², at least 50 m², at least 100 m², at least 1000 m², at least 0.01 km², at least 0.1 km², or at least 1 km².

In certain embodiments, the system comprises the solid fertilizer spreader.

In certain embodiments, the one or more sensors comprises at least one sensor mounted to the fertilizer spreader and at least one sensor positioned on or in one or more drones (e.g., drone-mounted), and wherein the fertilizer coverage value and/or the value and/or adjustment of the one or more fertilizer spreader parameters is/are determined by the processor using data received by the at least one spreader-mounted sensor and the at least one drone-mounted sensor.

In certain embodiments, the solid fertilizer comprises an agent to facilitate detection of the solid fertilizer by the one or more sensors. In certain embodiments, the agent comprises a dye, a tracer, or other contrast agent that is detectable by at least one of the one or more sensors and distinguishes the solid from the agricultural surface (e.g., soil, plant surfaces, etc.).

In certain embodiments, the solid fertilizer comprises granules, powder, and/or other particulate.

In certain embodiments, the target agricultural surface comprises soil.

In certain embodiments, the one or more sensors comprises at least one member of the group consisting of a visible wavelength imaging sensor (e.g., a camera, a red-green-blue (RGB) camera, a digital camera), an infrared wavelength imaging sensor (e.g., a Light Detection and Ranging (LiDAR) sensor, a shortwave infrared (SWIR) camera), and a radio detection and ranging (radar) sensor.

In certain embodiments, the solid fertilizer is a dry fertilizer.

In certain embodiments, the one or more sensors comprises at least one sensor mounted to or otherwise physically attached to or within the solid fertilizer spreader (e.g., the mechanical spreader).

In certain embodiments, the data captured by the one or more sensors comprises image data.

In certain embodiments, the instructions, when executed by the processor, cause the processor to use the data captured by the one or more sensors to compute the fertilizer coverage value on the target agricultural surface in terms of (i) an absolute or relative covered surface area, (ii) a number of pellets (or granules or other particles) or total solid volume for a given region of interest, and/or (iii) a measure of the uniformity of fertilizer distribution for the region of interest (e.g., the uniformity of fertilizer distribution over the swath of the target surface covered by distributed fertilizer).

In certain embodiments, the one or more fertilizer spreader parameters comprises at least one member selected from the group consisting of spreader speed, vane positioning, and spinner revolutions per minute.

In certain embodiments, the one or more fertilizer spreader parameters are adjustable parameters of a mechanical spreader or adjustable parameters of associated spreader equipment.

In another aspect, the invention is directed to a method comprising receiving, by a processor of a computing device, data (e.g., image data) captured by one or more sensors reflecting the state of a target agricultural surface after and/or before distribution of the solid fertilizer (e.g., data captured by one or more sensors of a system as described herein), and using the data to automatically determine, by the processor, either or both of (I) and (II) as follows: (I) a fertilizer coverage value on the target agricultural surface; and (II) a value and/or adjustment of one or more fertilizer spreader parameters (e.g., spreader speed, vane positioning, and/or spinner revolutions per minute) to achieve a desired level and/or uniformity of solid fertilizer coverage on the target agricultural surface.

In certain embodiments, the data captured by the one or more sensors comprises image data.

In certain embodiments, the one or more sensors comprises at least one member of the group consisting of a visible wavelength imaging sensor (e.g., a camera, a red-green-blue (RGB) camera, a digital camera), an infrared wavelength imaging sensor (e.g., a Light Detection and Ranging (LiDAR) sensor, a shortwave infrared (SWIR) camera), and a radio detection and ranging (radar) sensor.

In certain embodiments, the fertilizer coverage value is or comprises (i) an absolute or relative covered surface area, (ii) a number of pellets (or granules or other particles) or total solid volume for a given region of interest, and/or (iii) a measure of the uniformity of fertilizer distribution for the region of interest, e.g., the uniformity of fertilizer distribution over the swath of the target surface covered by distributed fertilizer.

In certain embodiments, the one or more fertilizer spreader parameters comprises at least one member selected from the group consisting of spreader speed, vane positioning, and spinner revolutions per minute.

In certain embodiments, the one or more fertilizer spreader parameters are adjustable parameters of a mechanical spreader or adjustable parameters of associated spreader equipment.

### BRIEF DESCRIPTION OF THE DRAWINGS

The foregoing and other objects, aspects, features, and advantages of the present disclosure will become more apparent and better understood by referring to the following description taken in conjunction with the accompanying drawings, in which:

FIG. 1 shows a photograph of a fertilizer spinner spreader.

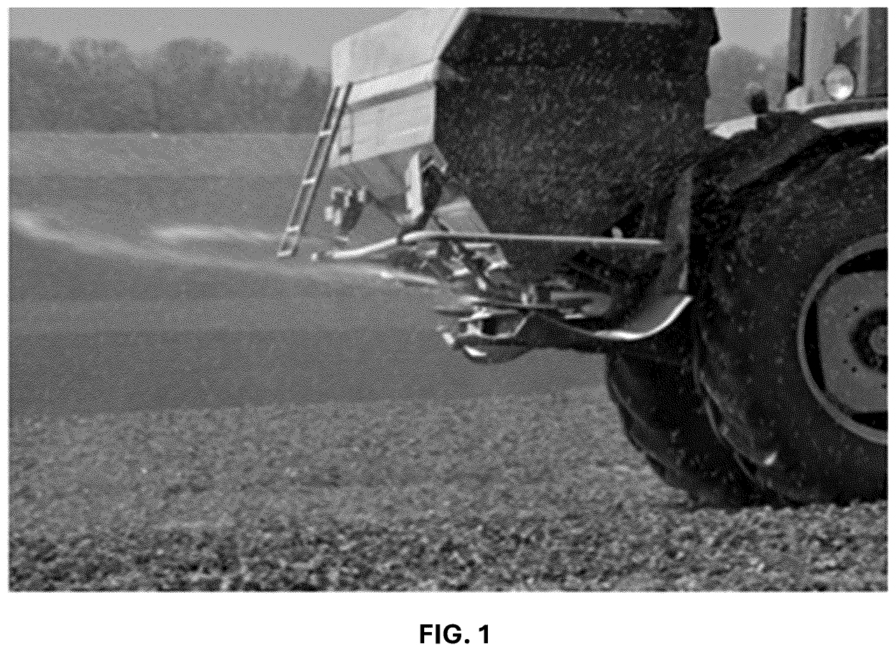

FIG. 2 shows exemplary graphs and a photograph illustrative of crop striping.

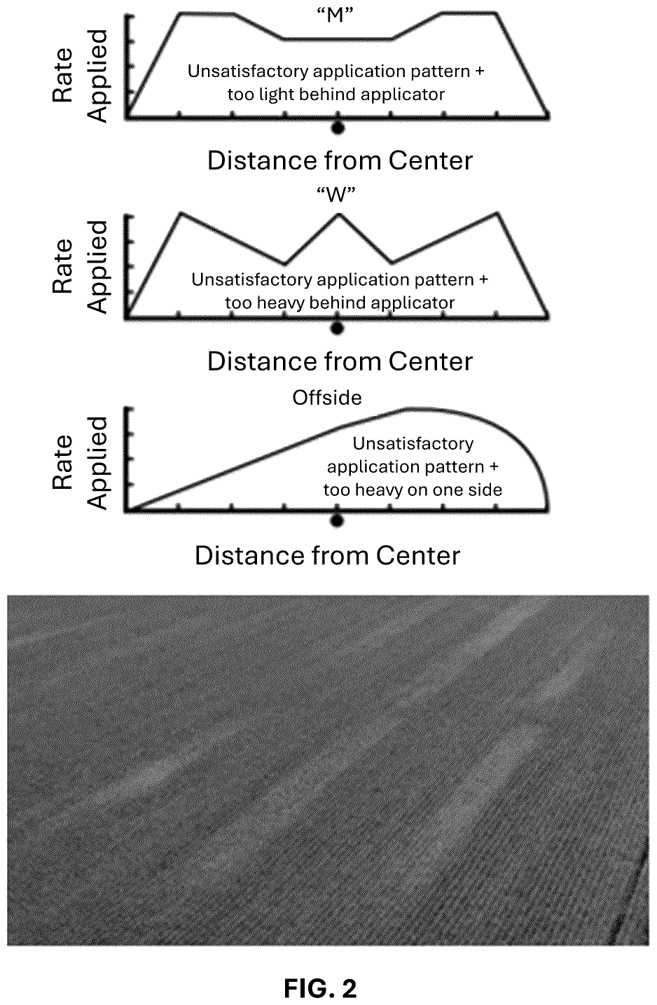

FIG. 3 shows an exemplary dry fertilizer spinner spreader and components thereof, according to an illustrative embodiment.

FIG. 4 shows a photograph of pan testing.

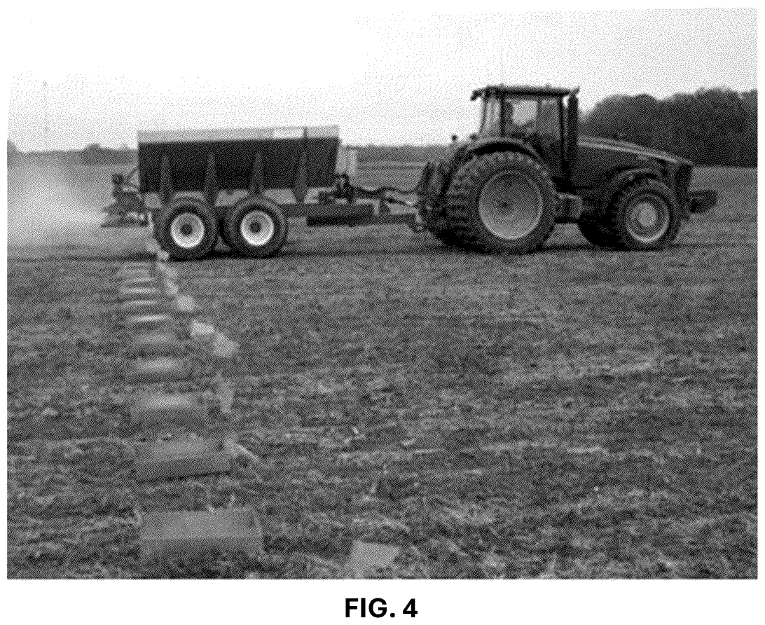

FIG. 5 shows an exemplary image obtained from a camera mounted to a spreader, according to an illustrative embodiment.

FIG. 6 is a schematic showing an implementation of a network environment for use in providing systems, methods, and architectures as described herein, according to an illustrative embodiment.

FIG. 7 is a schematic showing exemplary computing devices that can be used to implement the techniques described, according to an illustrative embodiment.

FIG. 8 is a block flow diagram of an exemplary method described herein, according to an illustrative embodiment.

FIG. 9 is a block diagram of an exemplary system described herein, according to an illustrative embodiment.

### DETAILED DESCRIPTION

It is contemplated that systems, architectures, devices, methods, and processes of the present claims encompass variations and adaptations developed using information from embodiments described herein. Adaptation and/or modification of the systems, architectures, devices, methods, and processes described herein may be performed, as contemplated by this description.

Throughout the description, where articles, devices, and systems are described as having, including, or comprising specific components, or where processes and methods are described as having, including, or comprising specific steps, it is contemplated that, additionally, there are articles, devices, systems, and architectures of the present disclosure that consist essentially of, or consist of, the recited components, and that there are processes and methods according to the present invention that consist essentially of, or consist of, the recited processing steps.

It should be understood that the order of steps or order for performing certain actions is immaterial so long as the invention remains operable. Moreover, two or more steps or actions may be conducted simultaneously.

The mention herein of any publication is not an admission that the publication serves as prior art with respect to any of the claims presented herein. The Background section may include concepts informed by the embodiments recited in the claims and further described elsewhere in the specification. The discussion of concepts in the Background section is not an admission that the subject matter discussed is prior art.

Headers are provided for the convenience of the reader—the presence and/or placement of a header is not intended to limit the scope of the subject matter described herein.

Presented herein are systems, methods, and devices for measurement and control of the coverage and/or spatial uniformity of dry (solid) fertilizer (e.g., powder, granules, and/or other particulate) that is automatically, mechanically distributed (e.g., via a spinner spreader) onto soil or another agricultural target.

In certain embodiments, the systems, methods, and devices described herein provide for accurate, easy-to-implement, real-time estimation of dry (solid) fertilizer coverage and deposition distribution (e.g., spatial uniformity of fertilizer deposition) on soil. While dry fertilizer spreaders have components with adjustable, interdependent parameters for improved coverage or distribution of fertilizer deposition on the soil, there is currently a lack of commercial systems that estimate the uniformity and effectiveness of a given spreader setting directly in real time, e.g., systems with tools that quantify fertilizer coverage on agricultural surfaces. Without such systems, farmers must run season- or year-long experiments to determine whether a certain set of parameters lead to desired crop yield. The inability to monitor fertilizer coverage directly on soil (e.g., in real time) also reduces the efficiency of spreader applications under changing environmental and on-field conditions. For example, a certain set of parameters that results in optimal fertilizer coverage when wind speeds are negligible, may be much less efficient when on-field wind speeds increased to as little as 2 to 3 miles per hour (mph) (about 3.2 to about 4.8 kilometers per hour (kmph)).

Real-time monitoring of fertilizer coverage directly on soil makes fertilizer spreading more efficient and also has broader implications on fertilizer use in general. Currently, farms are advised to apply fertilizer at a specific rate per acre (or per hectare) as specified by their agronomists. A fertilizer application rate is an amount (e.g., by weight) of fertilizer per unit area (e.g., per acre, per hectare (ha)). These rates are determined by field testing fertilizers under standard conditions in small acreage plots. However, such recommended application rates per acre (or per hectare) do not account for variabilities in application efficiency or variations in environmental or operational conditions on different fields. The ability to monitor fertilizer coverage on soil and other agricultural surfaces (e.g., plant surfaces) as provided by the embodiments described herein allow farms to move away from (or supplement) metrics such as application rates per acre (or per hectare) and move towards more relevant metrics such as application rates for a particular area (e.g., square centimeter) of soil.

In certain embodiments, systems presented herein measure and actively control solid fertilizer coverage on agricultural surfaces such as soils and plant surfaces. In certain embodiments, the measurement system includes (i) a sensor or group of sensors (optical or non-optical) (e.g., of a type such as a visible wavelength imaging sensor such as a camera, a digital camera, or a red-green-blue (RGB) camera, an infrared wavelength imaging sensor such as a Light Detection and Ranging (LiDAR) sensor or a shortwave infrared (SWIR) camera, and/or a radio detection and ranging (radar) sensor) that capture (e.g., in real time) the state of a target agricultural surface (e.g., soil surface, a plant surface(s)) after and/or before distribution of a dry (solid) fertilizer by a mechanical spreader onto said target surface (e.g., wherein the sensor or group of sensors are mounted to or otherwise physically attached to or within the mechanical spreader); and (ii) an algorithm or group of algorithms and a processor for processing data captured by the sensor or group of sensors to compute solid fertilizer coverage on the target agricultural surface (e.g., compute fertilizer coverage in terms of (i) absolute or relative covered surface area, (ii) number of pellets (or granules or other particles) or total solid volume for a given region of interest, and/or (iii) measure of the uniformity of fertilizer distribution for the region of interest, e.g., the uniformity of fertilizer distribution over the swath of the target surface covered by distributed fertilizer).

In certain embodiments, the algorithm or group of algorithms and processor uses the measurement of fertilizer coverage on the target agricultural surface (e.g., the real-time measurement) to determine a value and/or adjustment of one or more parameters to change (e.g., in real time) solid fertilizer coverage over the target surface (e.g., to improve uniformity of fertilizer distribution over the region of interest (e.g., swath) of the target surface). In certain embodiments, the one or more spreader parameters include, for example, spreader speed, vane positioning, and/or spinner revolutions per minute (rpm). In certain embodiments, the one or more spreader parameters are adjusted to achieve a desired level of coverage on the target surface (or the region of interest of the target surface).

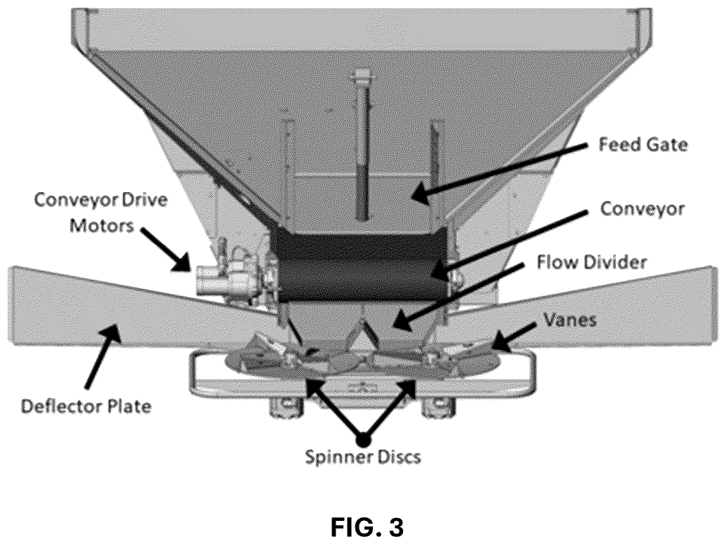

FIG. 3 shows an exemplary spinner spreader and various components of a dry (solid) fertilizer spinner spreader. An algorithm or group of algorithms as described herein can be used determine application appropriate adjustments to, for example, spinner discs, vanes, deflector plates, the conveyer, the feed gate, the flow divider, and/or the conveyer drive motors to achieve a desired level of coverage on a target surface (or a region of interest of a target surface). In some embodiments, a spreader may include one or more spinner discs, one or more vanes, one or more deflector plates, one or more conveyers, one or more feed gates (e.g., for fertilizer), one or more flow dividers, and/or one or more conveyer drive motors. In some embodiments, the height of a feed gate can be raised or lowered adjusted to allow more or less fertilizer to pass to the spinner discs. In some embodiments, positioning of the vanes can be adjusted. In some embodiments, the position of a flow divider can be adjusted relative to the position of the spinner discs. In some embodiments, the revolutions per minute (RPM) of a spinner disc can be adjusted.

In certain embodiments, spreader parameters can include adjustable parameters of associated spreader equipment. For example, associated spreader equipment can include the vehicle (e.g., a tractor, a truck, an all-terrain vehicle (ATV), a utility task vehicle (UTV), etc.) on which a spreader is mounted. In certain embodiments, the speed and/or direction of the vehicle can be altered to change (e.g., in real time) solid fertilizer coverage over a target surface.

In certain embodiments, the sensor or group of sensors includes at least one sensor positioned on or in one or more drones (unmanned aerial vehicles) that capture overhead images (e.g., visible spectrum, infrared, radio waves, or otherwise) of the target surface (e.g., including the region(s) of interest). In certain embodiments, the one or more drones capture one or more images of a region of interest of the target surface before (in time) a mechanical fertilizer spreader (e.g., an automatic, mechanical spreader with one or more adjustable parameters, e.g., a spreader that is a vehicle or is mounted on a vehicle) moves through the region of interest (and/or before the mechanical spreader distributes fertilizer onto the region of interest). After the spreader moves through the region of interest (and following distribution of the fertilizer), the one or more drones capture one or more images of the target surface, and the processor/algorithm(s) compute the spatial distribution and overage of distributed solid fertilizer (e.g., powder, granular material, and/or other particulate) on the target surface (e.g., soil). Depending on the frequency of imaging, the processor/algorithm(s) can then inform either discrete or continuous adjustments of the one or more adjustable parameters (e.g., spreader settings) to improve or optimize coverage going forward. In certain embodiments, the one or more drones are flying drones (e.g., remote controlled drones, global positioning system (GPS) drones, fixed wind drones, multi-rotor drones, single-rotor helicopter drones, and/or fixed-wing hybrid VTOL (vertical take-off and landing) drones). In certain embodiments, the one or more drones are capable of capturing images of a region of interest that spans at least 1 m², at least 10 m², at least 50 m², at least 100 m², at least 1000 m², at least 0.01 km², at least 0.1 km², or at least 1 km².

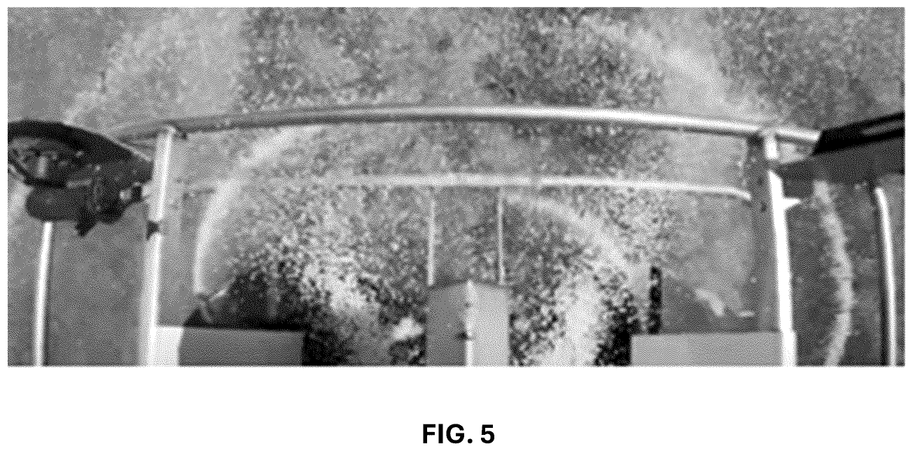

In other embodiments, the drone-based system described above is coupled with one or more cameras and/or other sensors mounted to the mechanical spreader. The camera(s) and/or sensor(s) can measure the initial trajectory of the particles and use particle mechanics (mechanics of powder, granules, and/or other solid particulate) to predict a final resting position of the particles. When coupled with drone-based images (overhead images), this can allow for continuous adjustment of the one or more adjustable parameters (e.g., spreader settings). FIG. 5 shows an image obtained from a camera mounted to a spreader, which is used in combination with images captured with the one or more drones.

In certain embodiments, data captured by the one or more sensors reflecting the state of a target agricultural surface can include data captured by environmental sensors. For example, environmental sensors can be used to capture environmental data corresponding to one or more environmental conditions at a location and at a time images from a drone and/or spreader are obtained. Exemplary environmental sensors include temperature sensors, humidity sensors, pressure sensors, wind sensors, light sensors, air quality sensors, gas sensors, rainfall sensors, radiation sensors, and soil sensors. It is also possible to account for environmental conditions such as wind, temperature, humidity, plant density, plant density variability, and the like, when determining fertilizer spreader parameters.

### Software, Computer System, and Network Environment

Certain embodiments described herein make use of computer algorithms in the form of software instructions executed by a computer processor. As described herein, in certain embodiments, computer algorithms can be used to determine (e.g., automatically determine) fertilizer coverage values on a target agricultural surface and to determine (e.g., automatically determine) a value and/or adjustment of one or more fertilizer spreader parameters to achieve a desired level and/or uniformity of solid fertilizer coverage on a target agricultural surface.

In certain embodiments, the software instructions include a machine learning module, also referred to herein as artificial intelligence (AI) software. As used herein, a machine learning module refers to a computer implemented process (e.g., a software function) that implements one or more specific machine learning techniques, e.g., artificial neural networks (ANNs), e.g., convolutional neural networks (CNNs), random forest, decision trees, support vector machines, and the like, in order to determine, for a given input, one or more output values. In certain embodiments, the input comprises alphanumeric data which can include numbers, words, phrases, or lengthier strings, for example. In certain embodiments, the input comprises data (e.g., image data) captured by one or more sensors reflecting the state of a target agricultural surface after and/or before distribution of the solid fertilizer, fertilizer coverage value, and/or a desired level and/or uniformity of solid fertilizer coverage on a target agricultural surface. In certain embodiments, the one or more output values comprise values representing numeric values, words, phrases, or other alphanumeric strings. In certain embodiments, the output values include fertilizer spreader parameters (e.g., adjusted fertilizer spreader parameters), fertilizer coverage value, and/or the level and/or uniformity of solid fertilizer coverage on a target agricultural surface.

In certain embodiments, machine learning modules implementing machine learning techniques are trained, for example using datasets that include categories of data described herein. Such training may be used to determine various parameters of machine learning algorithms implemented by a machine learning module, such as weights associated with layers in neural networks. In certain embodiments, once a machine learning module is trained, e.g., to accomplish a specific task such as identifying certain response strings, values of determined parameters are fixed and the (e.g., unchanging, static) machine learning module is used to process new data (e.g., different from the training data) and accomplish its trained task without further updates to its parameters (e.g., the machine learning module does not receive feedback and/or updates). In certain embodiments, machine learning modules may receive feedback, e.g., based on user review of accuracy, and such feedback may be used as additional training data, to dynamically update the machine learning module. In certain embodiments, two or more machine learning modules may be combined and implemented as a single module and/or a single software application. In certain embodiments, two or more machine learning modules may also be implemented separately, e.g., as separate software applications. A machine learning module may be software and/or hardware. For example, a machine learning module may be implemented entirely as software, or certain functions of an ANN module may be carried out via specialized hardware (e.g., via an application specific integrated circuit (ASIC)).

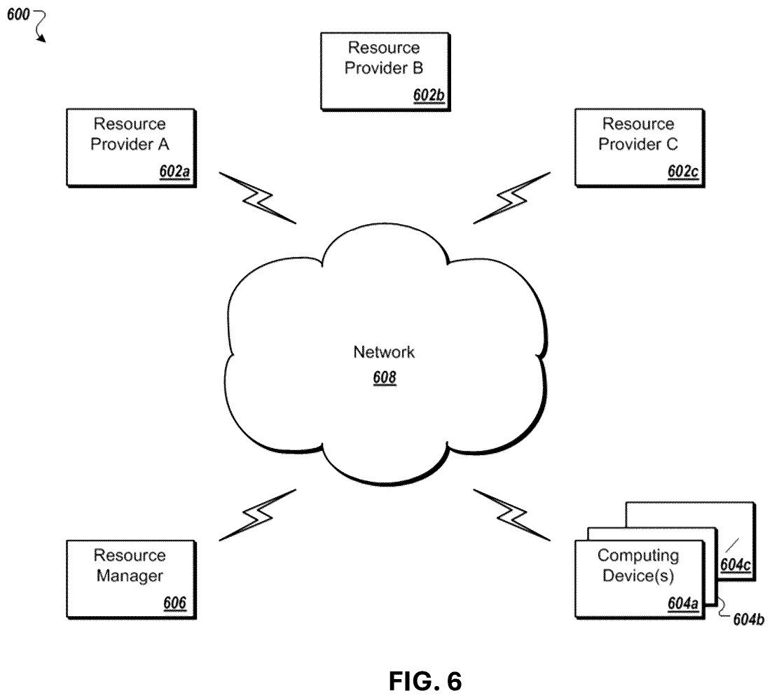

As shown in FIG. 6, an implementation of a network environment 600 for use in providing systems, methods, and architectures as described herein is shown and described. In brief overview, referring now to FIG. 6, a block diagram of an exemplary cloud computing environment 600 is shown and described. The cloud computing environment 600 may include one or more resource providers 602a, 602b, 602c (collectively, 602). Each resource provider 602 may include computing resources. In some implementations, computing resources may include any hardware and/or software used to process data. For example, computing resources may include hardware and/or software capable of executing algorithms, computer programs, and/or computer applications. In some implementations, exemplary computing resources may include application servers and/or databases with storage and retrieval capabilities. Each resource provider 602 may be connected to any other resource provider 602 in the cloud computing environment 600. In some implementations, the resource providers 602 may be connected over a computer network 608. Each resource provider 602 may be connected to one or more computing device 604a, 604b, 604c (collectively, 604), over the computer network 608.

The cloud computing environment 600 may include a resource manager 606. The resource manager 606 may be connected to the resource providers 602 and the computing devices 604 over the computer network 608. In some implementations, the resource manager 606 may facilitate the provision of computing resources by one or more resource providers 602 to one or more computing devices 604. The resource manager 606 may receive a request for a computing resource from a particular computing device 604. The resource manager 606 may identify one or more resource providers 602 capable of providing the computing resource requested by the computing device 604. The resource manager 606 may select a resource provider 602 to provide the computing resource. The resource manager 606 may facilitate a connection between the resource provider 602 and a particular computing device 604. In some implementations, the resource manager 606 may establish a connection between a particular resource provider 602 and a particular computing device 604. In some implementations, the resource manager 606 may redirect a particular computing device 604 to a particular resource provider 602 with the requested computing resource.

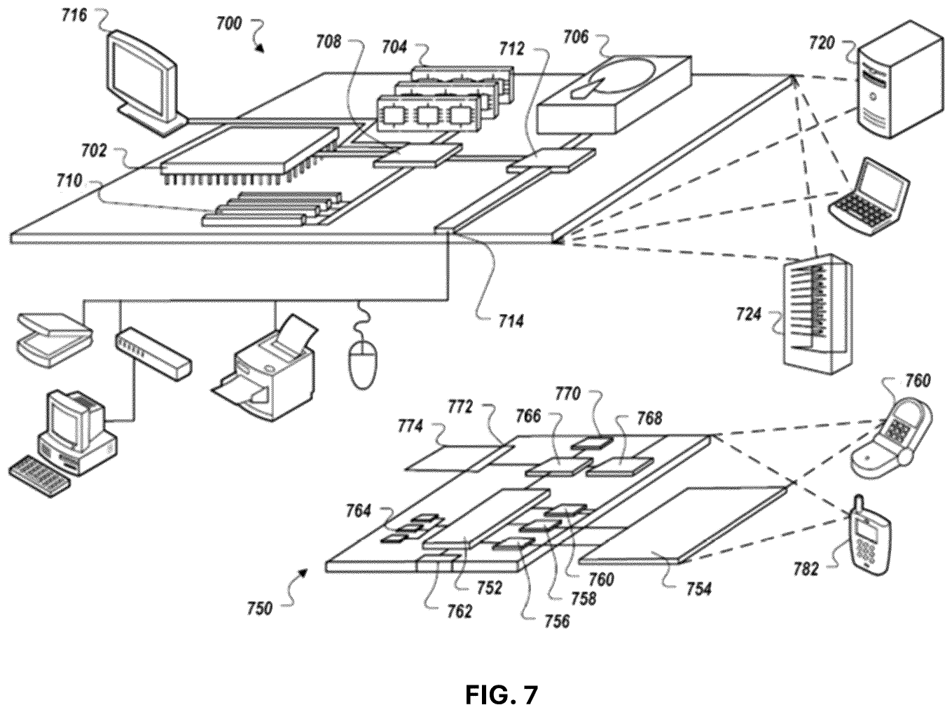

FIG. 7 shows an example of a computing device 700 and a mobile computing device 750 that can be used to implement the techniques described in this disclosure. The computing device 700 is intended to represent various forms of digital computers, such as laptops, desktops, workstations, personal digital assistants, servers, blade servers, mainframes, and other appropriate computers. The mobile computing device 750 is intended to represent various forms of mobile devices, such as personal digital assistants, cellular telephones, smart-phones, and other similar computing devices. The components shown here, their connections and relationships, and their functions, are meant to be examples only, and are not meant to be limiting.

The computing device 700 includes a processor 702, a memory 704, a storage device 706, a high-speed interface 708 connecting to the memory 704 and multiple high-speed expansion ports 710, and a low-speed interface 712 connecting to a low-speed expansion port 714 and the storage device 706. Each of the processor 702, the memory 704, the storage device 706, the high-speed interface 708, the high-speed expansion ports 710, and the low-speed interface 712, are interconnected using various busses, and may be mounted on a common motherboard or in other manners as appropriate. The processor 702 can process instructions for execution within the computing device 700, including instructions stored in the memory 704 or on the storage device 706 to display graphical information for a GUI on an external input/output device, such as a display 716 coupled to the high-speed interface 708. In other implementations, multiple processors and/or multiple buses may be used, as appropriate, along with multiple memories and types of memory. Also, multiple computing devices may be connected, with each device providing portions of the necessary operations (e.g., as a server bank, a group of blade servers, or a multi-processor system). Thus, as the term is used herein, where a plurality of functions are described as being performed by “a processor”, this encompasses embodiments wherein the plurality of functions are performed by any number of processors (one or more) of any number of computing devices (one or more). Furthermore, where a function is described as being performed by “a processor”, this encompasses embodiments wherein the function is performed by any number of processors (one or more) of any number of computing devices (one or more) (e.g., in a distributed computing system).

The memory 704 stores information within the computing device 700. In some implementations, the memory 704 is a volatile memory unit or units. In some implementations, the memory 704 is a non-volatile memory unit or units. The memory 704 may also be another form of computer-readable medium, such as a magnetic or optical disk.

The storage device 706 is capable of providing mass storage for the computing device 700. In some implementations, the storage device 706 may be or contain a computer-readable medium, such as a floppy disk device, a hard disk device, an optical disk device, or a tape device, a flash memory or other similar solid state memory device, or an array of devices, including devices in a storage area network or other configurations. Instructions can be stored in an information carrier. The instructions, when executed by one or more processing devices (for example, processor 702), perform one or more methods, such as those described above. The instructions can also be stored by one or more storage devices such as computer- or machine-readable mediums (for example, the memory 704, the storage device 706, or memory on the processor 702).

The high-speed interface 708 manages bandwidth-intensive operations for the computing device 700, while the low-speed interface 712 manages lower bandwidth-intensive operations. Such allocation of functions is an example only. In some implementations, the high-speed interface 708 is coupled to the memory 704, the display 716 (e.g., through a graphics processor or accelerator), and to the high-speed expansion ports 710, which may accept various expansion cards (not shown). In the implementation, the low-speed interface 712 is coupled to the storage device 706 and the low-speed expansion port 714. The low-speed expansion port 714, which may include various communication ports (e.g., USB, Bluetooth®, Ethernet, wireless Ethernet) may be coupled to one or more input/output devices, such as a keyboard, a pointing device, a scanner, or a networking device such as a switch or router, e.g., through a network adapter.

The computing device 700 may be implemented in a number of different forms, as shown in the figure. For example, it may be implemented as a standard server 720, or multiple times in a group of such servers. In addition, it may be implemented in a personal computer such as a laptop computer 722. It may also be implemented as part of a rack server system 724. Alternatively, components from the computing device 700 may be combined with other components in a mobile device (not shown), such as a mobile computing device 750. Each of such devices may contain one or more of the computing device 700 and the mobile computing device 750, and an entire system may be made up of multiple computing devices communicating with each other.

The mobile computing device 750 includes a processor 752, a memory 764, an input/output device such as a display 754, a communication interface 766, and a transceiver 768, among other components. The mobile computing device 750 may also be provided with a storage device, such as a micro-drive or other device, to provide additional storage. Each of the processor 752, the memory 764, the display 754, the communication interface 766, and the transceiver 768, are interconnected using various buses, and several of the components may be mounted on a common motherboard or in other manners as appropriate.

The processor 752 can execute instructions within the mobile computing device 750, including instructions stored in the memory 764. The processor 752 may be implemented as a chipset of chips that include separate and multiple analog and digital processors. The processor 752 may provide, for example, for coordination of the other components of the mobile computing device 750, such as control of user interfaces, applications run by the mobile computing device 750, and wireless communication by the mobile computing device 750.

The processor 752 may communicate with a user through a control interface 758 and a display interface 756 coupled to the display 754. The display 754 may be, for example, a TFT (Thin-Film-Transistor Liquid Crystal Display) display or an OLED (Organic Light Emitting Diode) display, or other appropriate display technology. The display interface 756 may comprise appropriate circuitry for driving the display 754 to present graphical and other information to a user. The control interface 758 may receive commands from a user and convert them for submission to the processor 752. In addition, an external interface 762 may provide communication with the processor 752, so as to enable near area communication of the mobile computing device 750 with other devices. The external interface 762 may provide, for example, for wired communication in some implementations, or for wireless communication in other implementations, and multiple interfaces may also be used.

The memory 764 stores information within the mobile computing device 750. The memory 764 can be implemented as one or more of a computer-readable medium or media, a volatile memory unit or units, or a non-volatile memory unit or units. An expansion memory 774 may also be provided and connected to the mobile computing device 750 through an expansion interface 772, which may include, for example, a SIMM (Single In Line Memory Module) card interface. The expansion memory 774 may provide extra storage space for the mobile computing device 750, or may also store applications or other information for the mobile computing device 750. Specifically, the expansion memory 774 may include instructions to carry out or supplement the processes described above, and may include secure information also. Thus, for example, the expansion memory 774 may be provide as a security module for the mobile computing device 750, and may be programmed with instructions that permit secure use of the mobile computing device 750. In addition, secure applications may be provided via the SIMM cards, along with additional information, such as placing identifying information on the SIMM card in a non-hackable manner.

The memory may include, for example, flash memory and/or NVRAM memory (non-volatile random access memory), as discussed below. In some implementations, instructions are stored in an information carrier. The instructions, when executed by one or more processing devices (for example, processor 752), perform one or more methods, such as those described above. The instructions can also be stored by one or more storage devices, such as one or more computer- or machine-readable mediums (for example, the memory 764, the expansion memory 774, or memory on the processor 752). In some implementations, the instructions can be received in a propagated signal, for example, over the transceiver 768 or the external interface 762.

The mobile computing device 750 may communicate wirelessly through the communication interface 766, which may include digital signal processing circuitry where necessary. The communication interface 766 may provide for communications under various modes or protocols, such as GSM voice calls (Global System for Mobile communications), SMS (Short Message Service), EMS (Enhanced Messaging Service), or MMS messaging (Multimedia Messaging Service), CDMA (code division multiple access), TDMA (time division multiple access), PDC (Personal Digital Cellular), WCDMA (Wideband Code Division Multiple Access), CDMA2000, or GPRS (General Packet Radio Service), among others. Such communication may occur, for example, through the transceiver 768 using a radio-frequency. In addition, short-range communication may occur, such as using a Bluetooth®, Wi-Fi™, or other such transceiver (not shown). In addition, a GPS (Global Positioning System) receiver module 770 may provide additional navigation- and location-related wireless data to the mobile computing device 750, which may be used as appropriate by applications running on the mobile computing device 750.

The mobile computing device 750 may also communicate audibly using an audio codec 760, which may receive spoken information from a user and convert it to usable digital information. The audio codec 760 may likewise generate audible sound for a user, such as through a speaker, e.g., in a handset of the mobile computing device 750. Such sound may include sound from voice telephone calls, may include recorded sound (e.g., voice messages, music files, etc.) and may also include sound generated by applications operating on the mobile computing device 750.

The mobile computing device 750 may be implemented in a number of different forms, as shown in the figure. For example, it may be implemented as a cellular telephone 780. It may also be implemented as part of a smart-phone 782, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms machine-readable medium and computer-readable medium refer to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term machine-readable signal refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (LAN), a wide area network (WAN), and the Internet.

The computing system can include clients and servers. A client and server are generally remote from each other and typically interact through a communication network. The relationship of client and server arises by virtue of computer programs running on the respective computers and having a client-server relationship to each other.

In some implementations, certain modules described herein can be separated, combined or incorporated into single or combined modules. Any modules depicted in the figures are not intended to limit the systems described herein to the software architectures shown therein.

### Exemplary Method

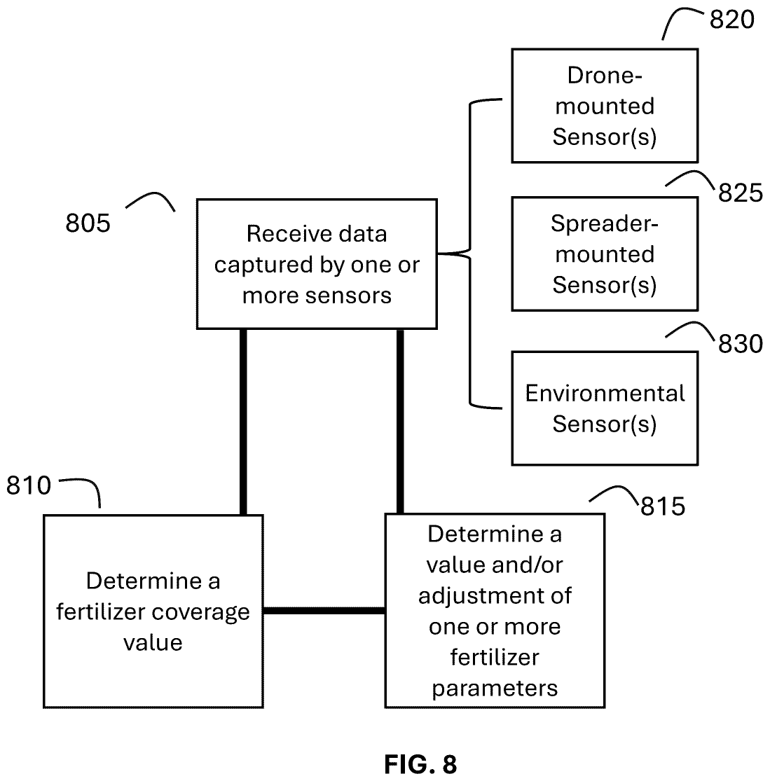

FIG. 8 is a block flow diagram of an exemplary method (800) as described herein.

In the method (800), data captured by one or more sensors reflecting the state of a target agricultural surface (e.g., soil) after and/or before distribution of the solid fertilizer is received by a processor of a computing device (805). The received data can then be used to automatically determine, by a processor, either or both of (I) a fertilizer coverage value on a target agricultural surface (810) and (II) a value and/or adjustment of one or more fertilizer spreader parameters (815) to achieve a desired level and/or uniformity of solid fertilizer coverage on a target agricultural surface. In certain embodiments, data captured by one or more sensors (805) and/or the fertilizer coverage value determined in (815) can be used to automatically determine a value and/or adjustment of one or more fertilizer spreader parameters (815) to achieve a desired level and/or uniformity of solid fertilizer coverage on a target agricultural surface.

In certain embodiments, the sensors comprise at least one sensor mounted to a fertilizer spreader (e.g., spreader-mounted) (820) and at least one sensor positioned on or in one or more drones (e.g., drone-mounted) (825). A fertilizer coverage value and/or a value and/or adjustment of one or more fertilizer spreader parameters as described herein is/are determined by a processor using data received by a spreader-mounted sensor (820) and a drone-mounted sensor (825).

In certain embodiments, data captured by sensors additionally comprise data (e.g., environmental data) captured by at least one environmental sensor (830).

### Exemplary System

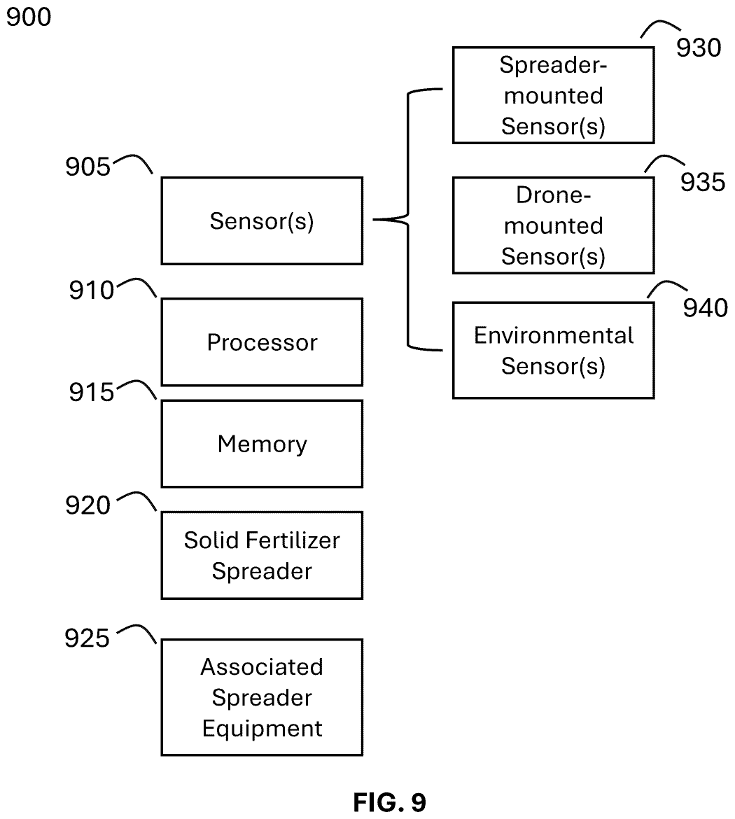

FIG. 9 is a block diagram of an exemplary system (900) as described herein.

In certain embodiments, a system (900) comprises one or more sensors (905) to capture data reflecting the state of a target agricultural surface after and/or before distribution of solid fertilizer by a spreader onto the target agricultural surface.

In certain embodiments, a system (900) comprises a processor of a computing device (910) and a memory (915) with stored instructions.

In certain embodiments, a system (900) includes a solid fertilizer spreader (920) (e.g., as shown in FIG. 3).

In certain embodiments, a system (900) includes associated spreader equipment (925) (e.g., as described herein).

In certain embodiments, a system (900) includes a least one sensor mounted to the fertilizer spreader (e.g., spreader-mounted) (930) and at least one sensor positioned on or in one or more drones (e.g., drone-mounted) (935). In certain embodiments, a fertilizer coverage value and/or the value and/or adjustment of one or more fertilizer spreader parameters is/are determined by a processor (910) using data received by at least one spreader-mounted sensor (930) and at least one drone-mounted sensor (935). In certain embodiments, sensors (905) can also include one or more environmental sensors (940) (e.g., as described herein).

Elements of different implementations described herein may be combined to form other implementations not specifically set forth above. Elements may be left out of the processes, computer programs, databases, etc. described herein without adversely affecting their operation. In addition, the logic flows depicted in the figures do not require the particular order shown, or sequential order, to achieve desirable results. Various separate elements may be combined into one or more individual elements to perform the functions described herein.

While the invention has been particularly shown and described with reference to specific preferred embodiments, it should be understood by those skilled in the art that various changes in form and detail may be made therein without departing from the spirit and scope of the invention as defined by the appended claims.

What is claimed is:

1. A system for automatically measuring solid fertilizer coverage on a target agricultural surface, the system comprising:
one or more sensors, wherein the one or more sensors capture data reflecting the state of the target agricultural surface after and/or before distribution of the solid fertilizer by a spreader onto said target agricultural surface;
a processor of a computing device; and
a memory having instructions stored thereon, wherein the instructions, when executed by the processor, cause the processor to:
receive the data captured by the one or more sensors reflecting the state of the target agricultural surface after and/or before distribution of the solid fertilizer; and
either or both of (I) and (II) as follows:
(I) use the data captured by the one or more sensors to automatically determine a fertilizer coverage value on the target agricultural surface; and
(II) use the data captured by the one or more sensors (and/or the fertilizer coverage value determined in (I)) to automatically determine a value and/or adjustment of one or more fertilizer spreader parameters to achieve a desired level and/or uniformity of solid fertilizer coverage on the target agricultural surface.

2. The system of claim 1, wherein the one or more sensors comprise at least one sensor positioned on or in one or more drones that capture overhead images of the target agricultural surface.

3. The system of claim 2, wherein the at least one sensor positioned on or in the one or more drones capture one or more images of a region of interest of the target surface before (in time) and/or after distribution of the solid fertilizer on the region of interest.

4. The system of claim 2, wherein the one or more drones capture the one or more images before and/or after a fertilizer spreader moves through the region of interest of the target agricultural surface.

5. The system of claim 3, wherein the fertilizer coverage value and/or the value and/or adjustment of the one or more fertilizer spreader parameters are determined using the one or more images captured by the one or more drones.

6. The system of claim 2, wherein the one or more drones are flying drones.

7. The system of claim 2, wherein the overhead images of the target agricultural surface depict a region of interest that spans at least 1 m², at least 10 m², at least 50 m², at least 100 m², at least 1000 m², at least 0.01 km², at least 0.1 km², or at least 1 km².

8. The system of claim 1, wherein the system comprises the solid fertilizer spreader.

9. The system of claim 1, wherein the one or more sensors comprises at least one sensor mounted to the fertilizer spreader and at least one sensor positioned on or in one or more drones, and wherein the fertilizer coverage value and/or the value and/or adjustment of the one or more fertilizer spreader parameters is/are determined by the processor using data received by the at least one spreader-mounted sensor and the at least one drone-mounted sensor.

10. The system of claim 1, wherein the solid fertilizer comprises an agent to facilitate detection of the solid fertilizer by the one or more sensors.

11. The system of claim 10, wherein the agent comprises a dye, a tracer, or other contrast agent that is detectable by at least one of the one or more sensors and distinguishes the solid from the agricultural surface.

12. The system of claim 1, wherein the solid fertilizer comprises granules, powder, and/or other particulate.

13. The system of claim 1, wherein the target agricultural surface comprises soil.

14. The system of claim 1, wherein the one or more sensors comprises at least one member of the group consisting of a visible wavelength imaging sensor, an infrared wavelength imaging sensor, and a radio detection and ranging (radar) sensor.

15. The system of claim 1, wherein the solid fertilizer is a dry fertilizer.

16. The system of claim 1, wherein the one or more sensors comprise at least one sensor mounted to or otherwise physically attached to or within the solid fertilizer spreader.

17. The system of claim 1, wherein the data captured by the one or more sensors comprises image data.

18. The system of claim 1, wherein the instructions, when executed by the processor, cause the processor to use the data captured by the one or more sensors to compute the fertilizer coverage value on the target agricultural surface in terms of (i) an absolute or relative covered surface area, (ii) a number of pellets (or granules or other particles) or total solid volume for a given region of interest, and/or (iii) a measure of the uniformity of fertilizer distribution for the region of interest.

19. The system of claim 1, wherein the one or more fertilizer spreader parameters comprises at least one member selected from the group consisting of spreader speed, vane positioning, and spinner revolutions per minute.

20. The system of claim 1, wherein the one or more fertilizer spreader parameters are adjustable parameters of a mechanical spreader or adjustable parameters of associated spreader equipment.

21. A method comprising receiving, by a processor of a computing device, data captured by one or more sensors reflecting the state of a target agricultural surface after and/or before distribution of the solid fertilizer, and using the data to automatically determine, by the processor, either or both of (I) and (II) as follows:
(I) a fertilizer coverage value on the target agricultural surface; and
(II) a value and/or adjustment of one or more fertilizer spreader parameters to achieve a desired level and/or uniformity of solid fertilizer coverage on the target agricultural surface.

22. The method of claim 21, wherein the data captured by the one or more sensors comprises image data.

23. The method of claim 21, wherein the one or more sensors comprises at least one member of the group consisting of a visible wavelength imaging sensor, an infrared wavelength imaging sensor, and a radio detection and ranging (radar) sensor.

24. The method of claim 21, wherein the fertilizer coverage value is or comprises (i) an absolute or relative covered surface area, (ii) a number of pellets (or granules or other particles) or total solid volume for a given region of interest, and/or (iii) a measure of the uniformity of fertilizer distribution for the region of interest.

25. The method of claim 21, wherein at least one of the one or more fertilizer spreader parameters comprises a member selected from the group consisting of spreader speed, vane positioning, and spinner revolutions per minute.

26. The method of claim 21, wherein the one or more fertilizer spreader parameters are adjustable parameters of a mechanical spreader or adjustable parameters of associated spreader equipment.
